(19) United States
(12) Patent Application Publication
(10) Pub. No.: US 2017/0206984 A1
(43) Pub. Date: Jul. 20, 2017

(54) END CAP FOR NUCLEAR FUEL ROD HAVING AN ANGLED RECESS AND WELDING THEREOF

(71) Applicant: TerraPower, LLC, Bellevue, WA (US)

(72) Inventors: Jeffrey Todd Lee, Forest, VA (US); Earl Brian Barger, Goode, VA (US); Scott Fitzner, Appomattox, VA (US); Roger D. Ridgeway, Bellevue, WA (US); Micah J. Hackett, Seattle, WA (US)

(21) Appl. No.: 15/277,869

(22) Filed: Sep. 27, 2016

Related U.S. Application Data
(63) Continuation-in-part of application No. 15/205,944, filed on Jul. 8, 2016, now abandoned.
(60) Provisional application No. 62/281,149, filed on Jan. 20, 2016.

(51) Int. Cl. G21C 3/10; G21C 21/02

(52) U.S. Cl. CPC G21C 3/10; G21C 21/02; G21Y 2004/30

(57) ABSTRACT

An end cap for a nuclear fuel rod and methods of welding the end cap to a cladding tube, particularly an HT9 end cap to an HT9 cladding tube, such as by resistance pressure welding or pressure resistance welding. The end cap includes an annular shoulder and an angled recess. Also provided are welding techniques and techniques for classifying fuel rod welds.

### CROSS-REFERENCE

This application is a continuation-in-part application of U.S. application Ser. No. 15/205,944 filed Jul. 8, 2016 titled “End Cap for Nuclear Fuel Rod and Welding Thereof,” which claims priority under 35 U.S.C. 119(e) to U.S. provisional application 62/281,149 filed Jan. 20, 2016 titled “Resistance Pressure Welding of Cladding Tubes,” and this application claims priority under 35 U.S.C. 119(e) to U.S. provisional application 62/281,149 filed Jan. 20, 2016 titled “Resistance Pressure Welding of Cladding Tubes,” the entire disclosures of all of which are incorporated herein by reference for all purposes.

### BACKGROUND

In a typical nuclear reactor, the reactor core generally includes a number of fuel assemblies, each of which is made up of an array of fuel rods. Each fuel rod includes a tubular cladding sealed by upper and lower end caps or plugs. The nuclear reactor core is made up of an array of such fuel assemblies.

### SUMMARY

Generally, the present disclosure provides an end cap for a nuclear fuel rod and methods of welding the end cap to a cladding tube of a fuel rod to yield a weld joint between the end cap and the cladding tube. The end cap includes an angled recess in the end that abuts the cladding tube.

One particular implementation described herein is an end cap for a nuclear fuel rod. The end cap has a tip end, an opposite abutment end for attaching to a cladding tube, and an outer surface. The abutment end has an angled recess therein and an annular shoulder defined by the outer surface of the end cap and by an outer wall of the recess. The outer wall of the angled recess forms an angle no less than 5 degrees with respect to the outer surface.

Another particular implementation described herein is another end cap for a nuclear fuel rod. The end cap has an abutment end for attaching to a cladding tube. The abutment end has an annular shoulder and an angled recess having an outer wall. The outer wall forms an angle no less than 95 degrees with respect to the annular shoulder.

Yet another particular implementation described herein is a fuel rod, comprising a cladding tube and an end cap. The end cap has an outer surface, an abutment end with an angled recess therein and an annular shoulder defined by the outer surface and an outer wall of the recess. The annular shoulder may be at least 0.05 mm wider than a wall thickness of the cladding tube.

Yet another particular implementation described herein is a method of forming a fuel rod from an end cap and a cladding tube. The method includes providing an end cap having an angled recess in an end, and attaching an end cap electrode to the end cap, and providing a cladding tube and attaching a cladding electrode thereto. The end cap and cladding tube are abutted, and a current is applied from the end cap electrode to the cladding electrode while applying a compressive force to the end cap and the cladding tube. A portion of the end cap and/or the cladding tube plastically deforms to form a weld joint.

The disclosure also generally provides methods of welding that include monitoring one or more weld parameters of the welding operation. The one or more weld parameters can include weld current, weld force, cladding tube extension and weld duration. Classifying the weld joint as satisfying a weld quality condition can be done if the welding operation is performed with one or more of the weld parameters satisfying a predetermined weld parameter condition.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. These and various other features and advantages will be apparent from a reading of the following detailed description.

### BRIEF DESCRIPTIONS OF THE DRAWING

The described technology is best understood from the following Detailed Description describing various implementations read in connection with the accompanying drawings.

FIG. 1 is a schematic diagram of a nuclear reactor core having multiple fuel rods, with a single fuel rod called out.

FIG. 2A is a schematic cross-sectional side view of a portion of a fuel rod, particularly, an end cap attached to a cladding tube; FIG. 2B is schematic cross-sectional side view of the end cap separated from the cladding tube; FIG. 2C is an enlarged portion of the end cap from FIG. 2B; FIG. 2D is an enlarged portion of an alternate implementation of an end cap.

FIG. 3 cross-sectional view taken along line 3-3 of FIG. 2A.

FIG. 4A is a schematic cross-sectional side view of another exemplary end cap;

FIG. 4B is a schematic end view of the end cap.

FIG. 5 is a schematic diagram of weld displacement.

FIG. 6 is a stepwise flow diagram of a method of welding an end cap and a cladding tube.

FIG. 7 is a photomicrograph of a weld between an end cap and a cladding tube.

FIG. 8 is a graphical representation of weld displacement as a function of measured weld current.

FIG. 9 is a graphical representation of a correlation for current as a function of weld cross section area.

FIG. 10 is a graphical representation of minimum weld displacement as a function of current.

### DETAILED DESCRIPTION

One particular type of nuclear reactor, traveling wave reactors (TWR), may include a sodium-cooled fast reactor designed for breed and burn equilibrium with a long fuel cycle without refueling. A TWR fuel assembly can be based on metallic fuel in stainless steel cladding, for example HT9 (Fe-12Cr-1MoV). Manufacturing of these fuel rods can include welding end caps to the top and bottom of the cladding tube, such as, for example, by resistance pressure welding (RPW), also referred to a pressure resistance welding (PRW).

The RPW process is capable of producing acceptable welds over wide parameter ranges for a variety of materials, including HT9. The RPW process can produce welds that are stronger than the cladding wall and that be used successfully for HT9 cladding tube closure welds in fuel rod fabrication, including to HT9 end caps.

As indicated above, provided herein is an end cap for a nuclear fuel rod and methods of welding the end cap to a cladding tube, particularly an HT9 end cap to an HT9 cladding tube. Also provided herein are welding techniques and techniques for classifying fuel rod cladding tube welds.

In the following description, reference is made to the accompanying drawing that forms a part hereof and in which are shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples provided below.

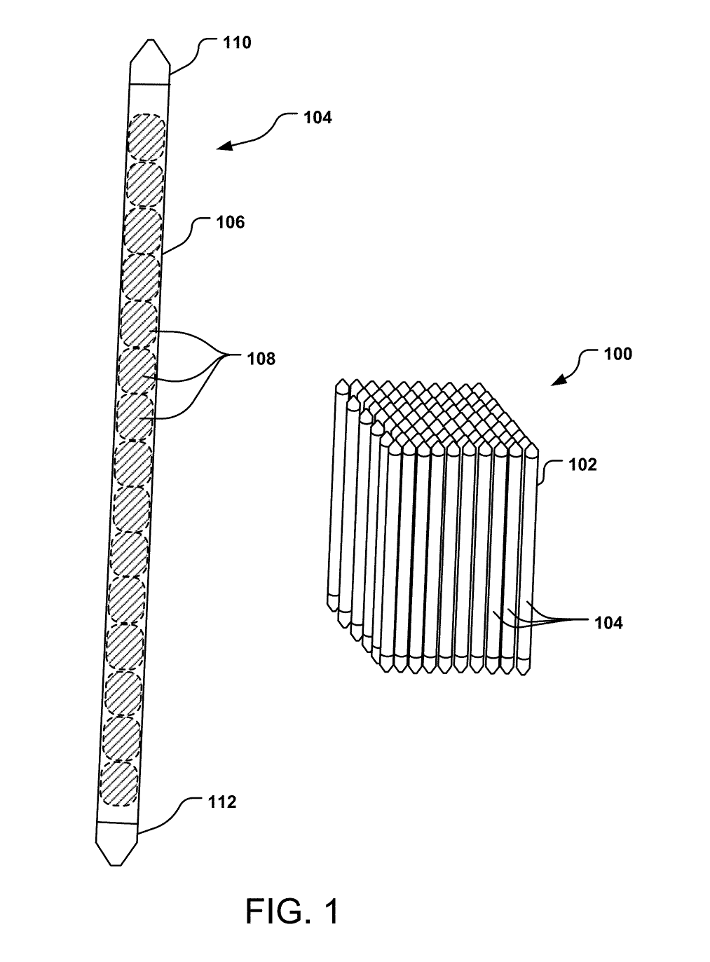

A nuclear reactor core 100, diagrammatically shown in FIG. 1, includes an array 102 of fuel rods 104. While the illustrative core 100 includes only a 6×10 array of fuel rods, a reactor can include thousands or tens of thousands of fuel rods 104, typically arranged in structural groups called fuel assemblies.

A single fuel rod 104 is also diagrammatically shown in FIG. 1. The fuel rod 104 includes a cladding tube 106 defining an interior in which is fissile material as fuel, in the illustrated implementation, a stack of fuel pellets 108. The cladding tube 106 is plugged at its upper end with an upper end cap 110 and is plugged at its lower end with a lower end cap 112. The plugging of the fuel rod 104 is by attachment of the upper end cap 110 and/or the lower end cap 112 to the cladding tube 106. This attachment of the caps 110, 112 needs to be sufficiently strong to withstand rupture during operation of the nuclear reactor.

The end caps 110, 112 can be girth or butt welded to the opposite ends of the cladding tube 106, for example by fusion welding or solid state welding. Resistance welding, e.g., resistance pressure welding (RPW) or pressure resistance welding (PRW), of the end caps, butted against the tube, can also be done to seal the rod 104. In this approach, a high current is passed through the cladding 106 and the end cap 110 or 112, as they are held under a compressive load. Resistance at the interface between the end cap 110, 112 and the cladding tube 106 generates localized heating resulting in melting of a portion of the material forming the end cap 110, 112 and/or the cladding tube 106, and hence forming a bond.

While resistance welding has many desirable attributes, including a weld bond line that is stronger than the cladding tube itself, the process has some shortcomings. For example, non-destructive weld examination is generally not feasible. Bond quality can also be susceptible to some contaminants, in some cases, with no means of detection. Weld upset, or flash, typically must be mechanically removed or suppressed in a post-weld process that complicates the processing.

However, disclosed herein are weld parameters developed to provide a range of weld parameters, including currents, over which cladding tubes 106 could be successfully and consistently joined with the end caps 110, 112. The resulting resistance welds meet non-destructive and destructive examination requirements.

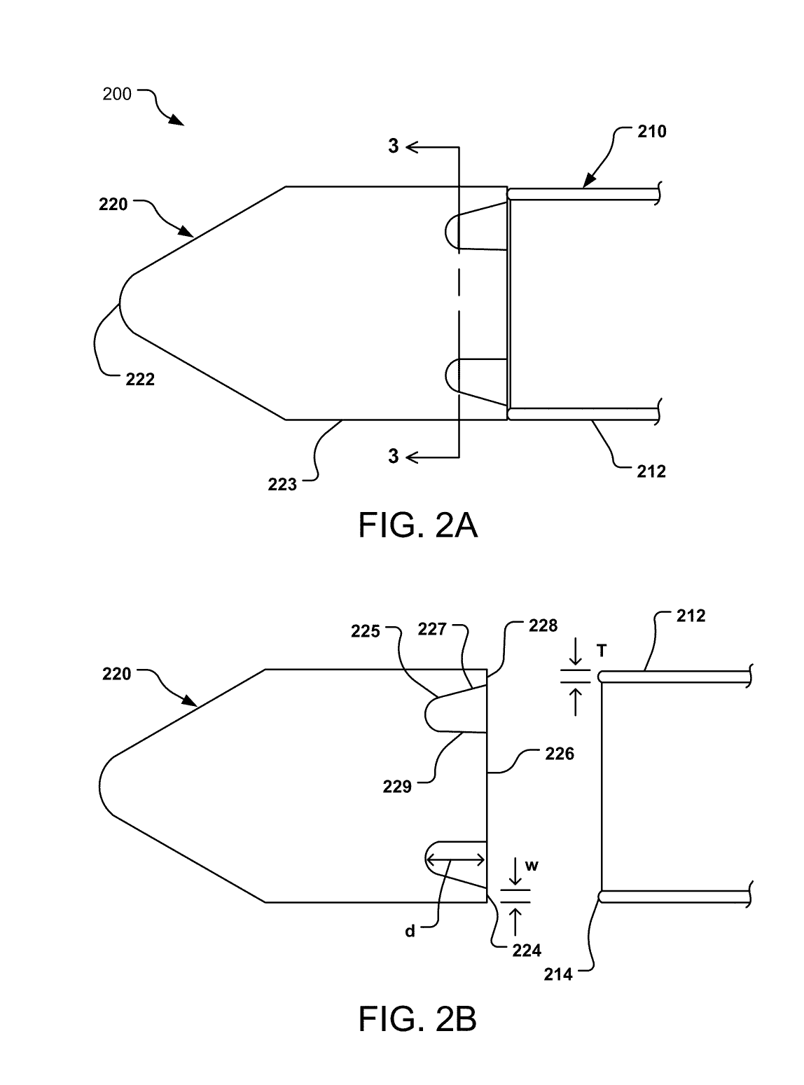

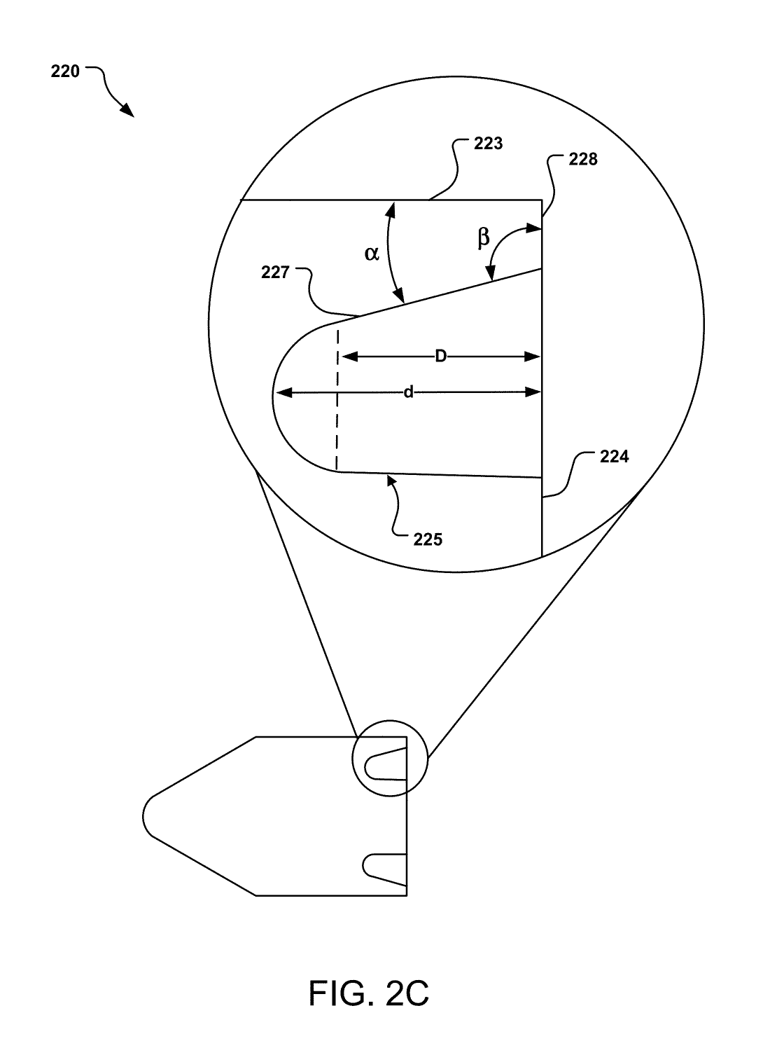

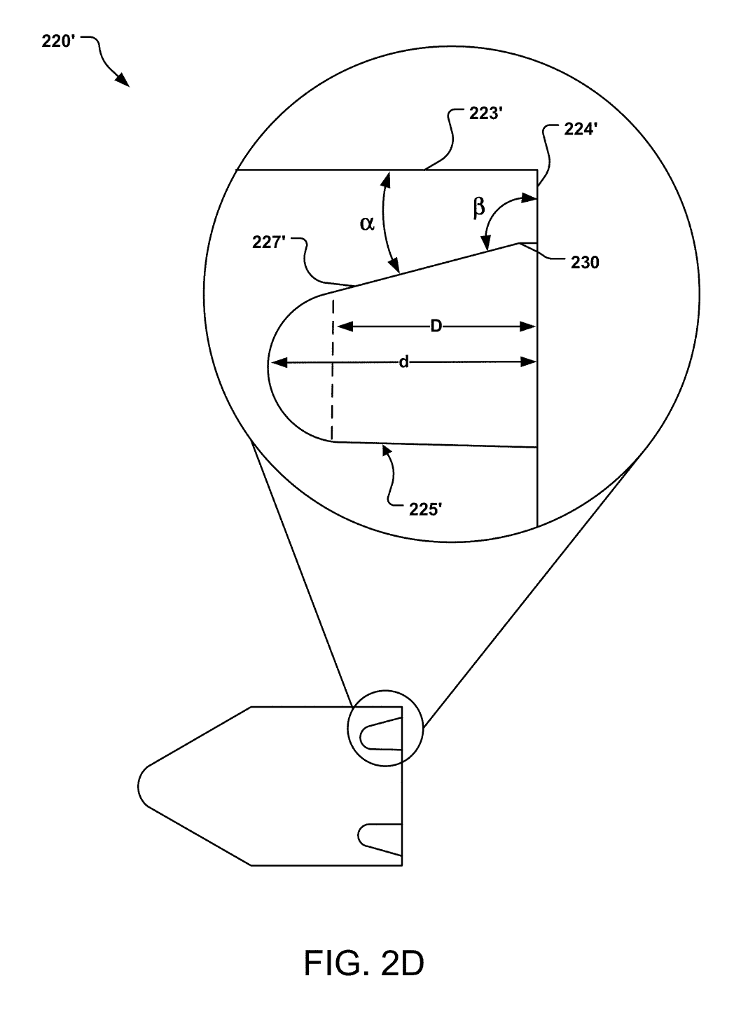

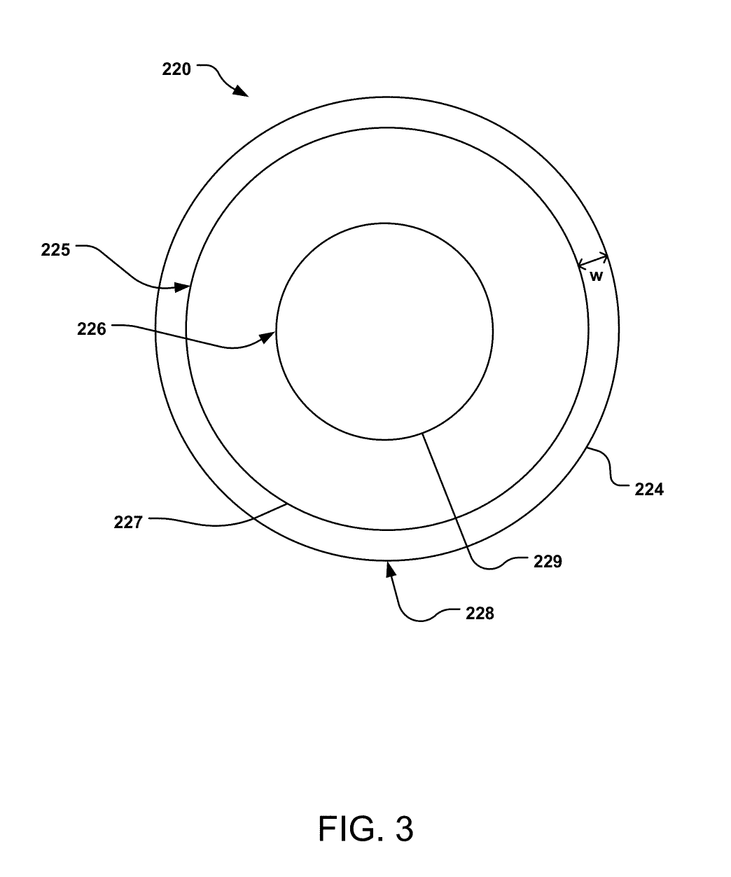

FIGS. 2A, 2B, 2C and 3 illustrate a particular implementation of an end cap that is particularly conducive to pressure resistance welding resulting in acceptable welds when joined with the developed weld parameters.

FIGS. 2A and 2B illustrate a portion of a fuel rod 200, particularly, a section of a cladding tube 210 and an end cap 220. The end cap 220 can be either an upper end cap or a lower end cap. Examples of suitable materials for the cladding tube 210 and/or the end cap 220 include various alloys, such as Fe-based stainless steel 422, Fe-based T91 (Fe-9Cr-1MoVNb) and T92, Fe-based oxide dispersion strengthened (ODS) steels, 316 stainless steel, D9 stainless steel (which is similar to 316SS but with Ti addition), and Fe-based HT9 (Fe-12Cr-1MoV).

In this particular implementation, the cladding tube 210 has a cylindrical wall 212 with a thickness T and a terminal end 214. The end 214 has a surface area based on the thickness T of the wall 212 and the inner diameter and the outer diameter of the wall 212.

Particular examples suitable for the cladding tube 210 have the dimensions provided in Table 1.

TABLE 1

| | | | wall thickness | Terminal end |
|---|---|---|---|---|
| Sample | OD (mm) | ID (mm) | “T” (mm) | area (mm²) |
| 1 | 6.70 | 5.98 | 0.38 | 6.60 |
| 2 | 6.70 | 5.80 | 0.45 | 8.84 |
| 3 | 6.70 | 5.58 | 0.56 | 10.80 |
| 4 | 8.35 | 7.23 | 0.56 | 13.70 |

The end cap 220, which in this implementation is generally conical with a cylindrical base extension, has a tip end 222 and a circular base 223 with an end surface 224 configured to abut the wall 212 of the cladding tube 210. The base 223 has an exterior surface with an outer diameter essentially the same as the outer diameter of the wall 212 of the cladding tube 210.

Inward from the exterior surface of the base 223, present in the abutment end surface 224, is a recess, particularly an annular channel or groove 225 that forms an angled undercut. As seen in FIG. 2B and FIG. 3, the angled groove 225 has an outer wall 227 and an inner wall 229 and separates a central pedestal 226 from a perimeter, annular shoulder area 228. The annular shoulder area 228 is present on, in, or otherwise is the abutment end surface 224 between the outer surface of the cap 220 and the outer wall 227 of the angled annular groove 225.

The angled annular groove 225 also has a radial width or thickness between the outer wall 227 and the inner wall 229, when measured at the end surface 224, of at least 0.5 mm. In some implementations, the angled annular groove 225 has a width of 0.5-4 mm, in other implementations 1-2 mm. One exemplary width is 1.37 mm.

Referring now to FIG. 2C, the outer wall 227 of the angled annular groove 225 and the exterior surface of the base 223 at the abutment end surface 224 form an angle α, which in some implementations is no less than 5 degrees but less than 90 degrees (i.e., greater than or equal to 5 degree and less than 90 degree). In some implementations, this angle α is 10-80 degrees, e.g., 10-20 degrees or 70-80 degrees. One exemplary angle α is 15 degrees, and another exemplary angle α is 75 degrees. The outer wall 227 also forms an angle β with the abutment end surface 224, particularly, the annular shoulder area 228, which in some implementations is no less than 95 degrees but less than 180 degrees (i.e., greater than or equal to 95 degree and less than 180 degrees). In some implementations, this angle β is 100-165 degrees. One exemplary angle β is 105 degrees. Thus, for at least a portion of the depth of the angled groove 225, the distance between the outer wall 227 of the angled groove 225 and the exterior surface of the base 223 of the end cap 220 is not constant but increases along the depth of the annular groove 225. This outer wall angle, either angle α or angle β, defines the angle of the outer wall 227 and is the basis for the angled recess or groove.

In accordance with the paragraph above and as described further below, the invention presented here includes an end cap having an angled recess, such as an angled groove, the outer wall angle defined by the outer wall of the recess being no less than 5 degrees in respect to the outer wall of the end cap proximate the abutment end of the end cap, and/or the outer wall of the recess being no less than 95 degrees in respect to the abutment end of the end cap. Although angles of less than 5 degrees and/or 95 degrees may be disclosed and enabled herein, Applicant specifically disclaims rights to an end cap that has both an angled recess with an outer wall having an angle less than 5 degrees with respect to the exterior wall and an outer wall having an angle less than 95 degrees with respect to the abutment end.

As seen in FIG. 2C and also FIG. 2B, the angled annular groove 225 has a depth d from the abutment end surface 224 to its terminal end opposite from and distal in respect to the abutment end surface 224; this depth d is at least 0.5 mm. In some implementations, the annular groove 225 has a depth d of 0.5-5 mm, in other implementations 1-3 mm. One exemplary depth d is 1.78 mm.

Depending on the technology used to create the angled groove 225 in the end cap 220, the groove 225 may have a rounded terminal end; the portion of the depth of the groove 225, without the rounded terminal end, is depth D, seen in FIG. 2C. At least a significant portion of the outer wall 227, from the abutment end surface 224 for the depth D, has the angled or sloped outer wall angle, having one or both of an angle α no less than 5 degrees and less than 90 degrees and an angle β no less than 95 degrees and less than 180 degrees. In some implementations, the entire depth D of the outer wall 227 does not have the outer wall angle, but at least a significant portion of the outer wall 227 does; e.g., at least 50% of the depth D of the outer wall 227 has the outer wall angle, e.g., at least 75% of the depth D of the outer wall 227 has the outer wall angle. For example, the angled outer wall 227 may extend from the abutment end surface 224 for 2 mm, with the recess depth D being 3 mm.

In another implementation, shown in FIG. 2D, an end cap 220′ has an angled groove 225′ where the angled portion of the angled outer wall 227′ does not initiate at the abutment end surface 224′, but rather the outer wall angle initiates its angle α or angle β at an initiation point 230 proximate the abutment end surface 224′. For example, the initiation point 230 may be about 0.5 mm or 1 mm from the abutment end surface 224′ and be considered proximate the abutment end surface 224′. Additionally or alternately, the initiation point 230 may be, e.g., about 1% or 5% or 10% (of the depth D) from the abutment end surface 224′ and be considered proximate the abutment end surface 224′. For example, the angled outer wall 227′ may have its initiation point 230 about 0.5 mm from the abutment end surface 224′ and extend at its angle α or angle β for 1.5 mm, with the recess depth D being 3 mm.

The inner wall 229 of the angled annular groove 225 may be parallel to the outer wall 227 or may be angled in either direction.

As seen in FIG. 2B and in FIG. 3, the annular shoulder area 228 of the abutment end surface 224 between the exterior surface of the end cap base 223 and the angled annular groove 225 has a width w. This width w is no less than the thickness T of the cylindrical wall 212 of the cladding tube 210; this can be represented by w≧T. In some implementations, the width w is at least 0.05 mm greater than the wall thickness T, and in other implementations at least 0.1 mm greater than the wall thickness T. In these implementations, the width w, however, is not more than 1 mm greater, and in some implementations not more than 0.5 mm than the wall thickness T. An example width w is 0.125 mm greater than the wall thickness T, and another example is 0.15 mm greater. Additionally or alternately, the width w is at least 10% greater than the wall thickness T, and in other implementations 30% or 35% greater than the wall thickness T. In these implementations, the width w, however, is not more than 75% greater than the wall thickness T.

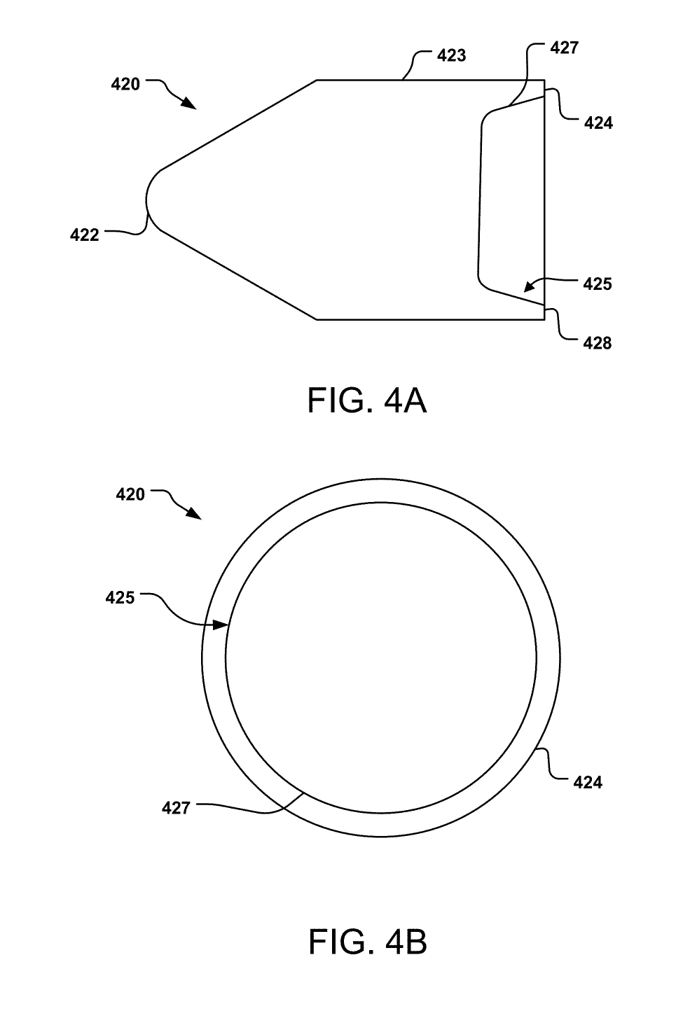

An alternate implementation of an end cap is illustrated in FIGS. 4A and 4B as end cap 420. The end cap 420 has various features similar to the end cap 220, except without an annular groove or a central pedestal.

The end cap 420 has a tip end 422 and a base 423 with an end surface 424 configured to abut the wall of a cladding tube. Inward from the outer surface of the base 423, present in the abutment end surface 424, is a recess 425 formed by an angled or sloped wall 427 that forms an angled undercut. An annular shoulder area 428 is present on, in, or otherwise is the abutment end surface 424 between the exterior surface of the cap 420 and the angled wall 427 forming the angled recess 425.

The various dimensions and features of the end cap 420 are similar to the dimensions and features discussed above in respect to the end cap 220.

It is noted that although the end caps 220, 420 are illustrated as generically conical with a cylindrical base and a rounded tip at the conical portion, the end caps 220, 420 may have any shape or structure, such as a domed end, a flat end, entire tapered, or entire conical, or an intricate design.

During welding (e.g., PRW or RPW), an electrode is placed on each of the cladding tube and the end cap. The cladding tube and the end cap are held in abutting engagement and a high current is passed across the parts. Resistance, due to the material (e.g., HT9), generates localized heating resulting in a bond between the two parts.

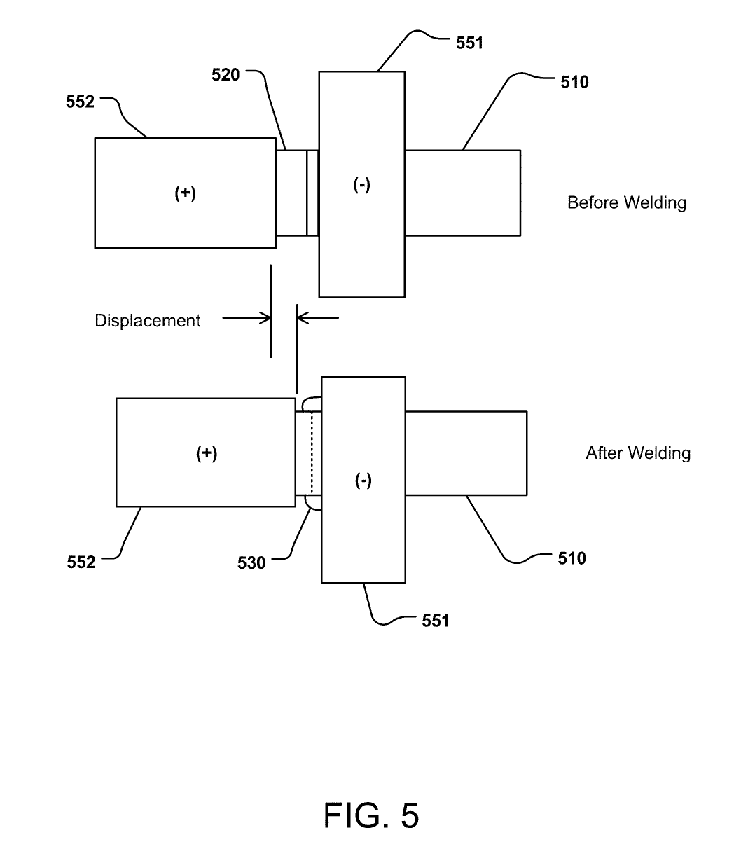

In FIG. 5, a cladding tube 510 is abutted to an end cap 520. The cladding tube 510 is electrically connected to a cladding electrode 451 and the end cap 520 is electrically connected to an end cap electrode 552. The amount of cladding tube 510 that extends beyond the face of the cladding electrode 551, toward the end cap 520, is referred to as the cladding extension. After welding, a weld 530 is formed at the abutment of the cladding tube 510 and the end cap 520 by the plastic deformation of material from either or both the cladding tube 510 and the end cap 510; however, a mass of material has been displaced from the end cap 520 and/or the cladding tube 510 (particularly, the cladding extension) and solidified as part of the weld 530 with a diameter greater than both the original end cap 520 and the cladding tube 510. This excess material, often called the “upset”, creates a weld joint 530 that is much thicker than the cladding tube wall thickness. In some implementations, the upset provides increased strength to the weld.

To better control the upset and obtain consistency across multiple fuel rods, an end cap as described above in FIGS. 2A, 2B, 2C and 3 and/or FIGS. 4A and 4B, is utilized.

By including an annular shoulder (e.g., annular shoulder 228, 428), the current during the welding process is localized in a smaller annular area and thus within a smaller volume of material. When no annular shoulder is present, in some implementations, much higher current is needed to obtain an acceptable weld joint. A higher current used with no annular shoulder can result in localized melting of the material and/or undesirable metal expulsion from the weld area. Having the annular shoulder decreases and limits the amount of material from the end cap that must be heated and deformed in order to create a good joint with the cladding tube.

Additionally, the undercut area adjacent to the annular shoulder (e.g., the angled groove 225 or the angled recess 425) accommodates any undesired metal expulsion from the weld area by providing a volume into which the material can flow. The sloped or angled wall that forms the annular shoulder (e.g., outer wall 227 of the angled groove 225, or wall 427 of the angled recess 425) may direct the flow of any excess material away from the weld joint. In other words, an angled or sloped wall could facilitate the flow of molten material away from the weld area.

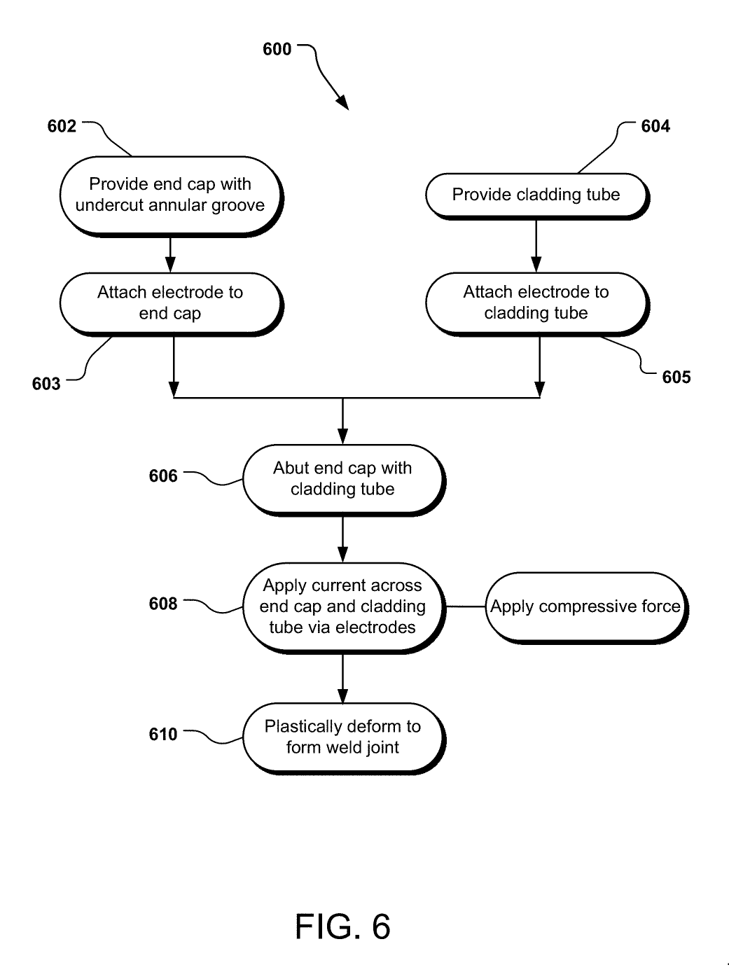

FIG. 6 is a flow diagram of an example method 600 for attaching an end cap to a cladding tube for a fuel rod.

In operation 602 an end cap is provided; the end cap includes an angled annular groove formed by a sloped or angled outer wall. In an alternate operation, an end cap having an angled center recess is provided. In either operation, the end cap has an annular shoulder and may be formed from HT9. An electrode is attached to the end cap in operation 603. In operation 604 a cladding tube is provided, and in operation 605 an electrode is attached to the cladding tube. The cladding tube may be formed from HT9.

In operation 606 the end cap and cladding tube are abutted. A weld current is applied across the end cap and the cladding tube for a predetermined time, via the electrodes, in operation 608 while simultaneously applying a compressive weld force. A portion of either or both the end cap and the cladding tube plastically deforms to form a weld joint in operation 610.

If one or more of the weld parameters such as weld current, weld force, cladding tube extension and weld duration are within a predetermined parameter condition, the weld joint satisfies a weld quality condition

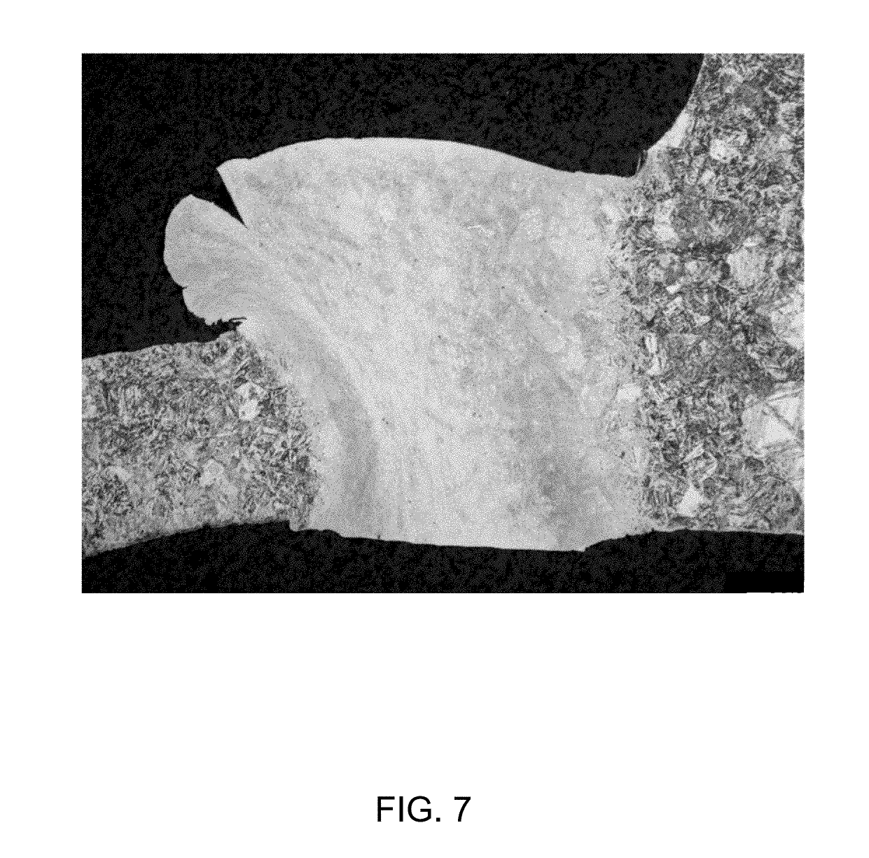

FIG. 7 illustrates an acceptable weld between a cladding tube and an end cap having a sloped annular grove, the weld having been formed by RPW. The cladding tube is on the left in the photograph and the end cap is on the right, with the exterior or outer surface of the two parts towards the bottom of the photograph. It can be readily seen that the end cap has a groove wall that is sloping away from the outer surface of the end cap and that it has an annular shoulder that is thicker than the thickness of the cladding tube wall. The weld joint is thick with good metal adhesion to both the cladding tube and the end cap.

Returning to FIG. 5, this figure also schematically shows weld displacement, which is a measure of the change in position of the end cap electrode after welding in respect to before welding. FIG. 5 shows how the end cap 520 and end cap electrode 552 has shifted closer to the cladding tube 510 and cladding electrode 551 after welding. It was found that the weld displacement, as a function of measured current, increases with increasing cladding cross sectional area. In other words, a larger cladding tube terminal end area requires more current to displace the weld a given distance. Similarly, smaller cladding tube end areas require less current to displace the end cap electrode.

Various welding parameters affect the weld joint between a cladding tube and an end cap, particularly when both the cladding tube and end cap are HT9. Several resistance welding parameters, including current, tube wall thickness and/or area, cladding tube extension distance, weld force of the end cap electrode, weld current, and weld duration were developed over which cladding tubes could be successfully and consistently joined with an end cap.

Resistance pressure welding of HT9 samples typically results in a quality weld joint between the end cap and the cladding tube. If the weld current or weld force is too low, the end cap may not properly bond to the cladding tube. If too much weld force or too high of a weld current is used, then fusion of the joint would occur with significant expulsion of metal (upset), and localized melting may occur.

After welding, room temperature burst testing may be performed to test the weld durability and determine the failure location of a sample. Room temperature burst testing is a metric for determining weld quality. If rupture of the sample occurs in the cladding wall, the sample is a successful burst test. If rupture of the sample occurs in the weld joint or heat affected zone, then the sample fails burst testing.

Table 2 shows four different weld input parameters for RPW, their corresponding effects on measured outputs, and examples of destructive test results used to examine weld quality.

TABLE 2

| Input Parameter | Output Measure | Example Destructive Tests |
|---|---|---|
| Weld current | Weld current | Burst testing at room |
| | | temperature |
| Weld force | Weld displacement | Metallography |
| Tube extension | Upset dimension | Micro-hardness |
| Weld duration | Visual appearance | Burst testing at high |
| | | temperature |

Of the four input parameters in Table 2, weld quality is most sensitive to the weld current. Performing a current sweep establishes the relationship between current, displacement, and room temperature burst test performance. Current ranges may be selected based on visual appearance and burst test performance. The process extremes may be evaluated during the current sweep. Minimum current samples are expected to fail room temperature burst tests, as the current is insufficient to provide for adequate bonding. High current samples may exhibit melting, metal expulsion, and other potentially detrimental conditions. While high current samples typically produce a thick bond line, the amount of metal expulsion (upset) may produce a significantly larger outer diameter, and therefore may not be desirable for the weld conditions.

Ten samples were prepared by RPW for each of the four cladding tube samples (made from HT9) from Table 1 for a current sweep test. The cladding tubes were welded to an end cap (made from HT9) as illustrated in FIGS. 2A, 2B and 2C. Programmed current was incrementally increased for each sample condition, and the measured current and weld displacement were recorded for each sample. The measured current is typically more than the programmed (input) current and therefore a better metric for the energy input in the weld process. Weld duration was fixed at a constant value for the testing.

Samples that pass burst testing had a thick weld joint between the cladding and the end cap. FIG. 7 shows a sample of an acceptable weld joint.

Weld displacement is a measure of the change in position of the end cap electrode before and after welding; this is shown schematically in FIG. 5. The weld displacement vs. measured current increases with increasing cladding cross sectional area. In other words, a larger terminal end area (or, weld cross section) requires more current to displace the weld a given distance. Similarly, smaller weld cross sections require less current to displace the end cap electrode.

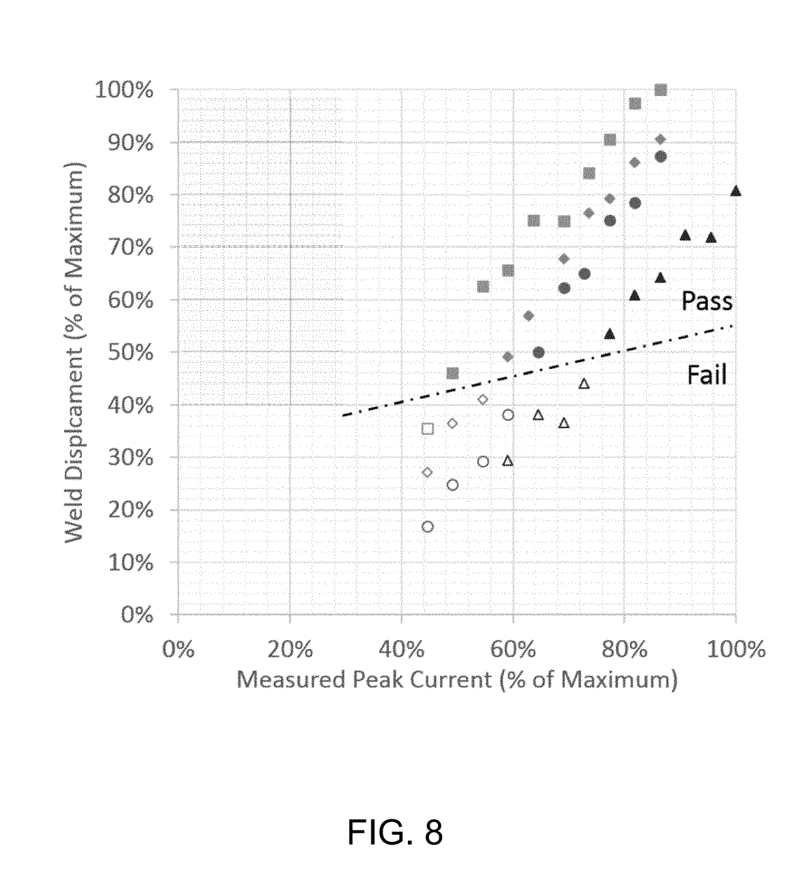

FIG. 8 shows a scatterplot of the weld displacement as a function of measured weld current, with values normalized as a function of the maximum values observed. Displacement values are shown for all four sample designations. Samples that passed the burst test are those that were welded at higher current, while all lower current welds for a given sample type failed the burst test. The result is a well-defined “line” for the minimum current required to result in a successful weld that will pass burst testing.

The results for the current sweep in the weld development produced a trend that can be used for predictive purposes of weld performance.

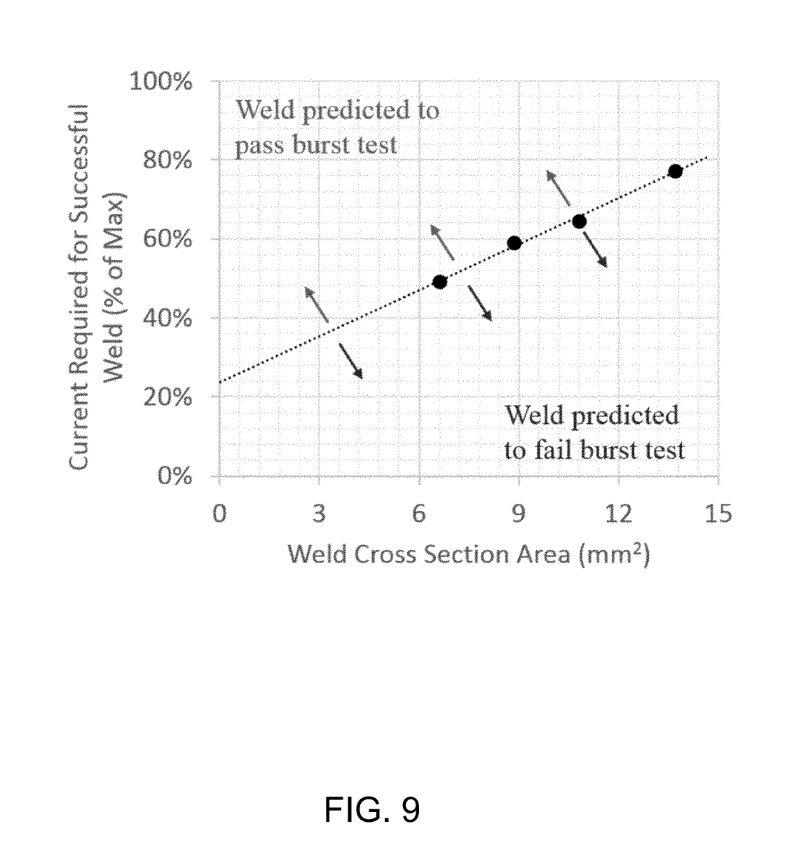

First, changing cladding tube dimensions will result in a different cross section area that will subsequently require a different set of weld parameters for successful joining of the end cap to the cladding tube. Based on the minimum current required for a successful burst test for each of the cladding designations, a correlation was developed for current as a function of the weld cross section area; see FIG. 9. This graph shows a prediction for the minimum weld current required for a successful weld joint based on a given weld cross section area. Selecting a weld current somewhat higher than this minimum current line should result in a successful weld joint. This relationship may be used for translating weld results to other joint configurations.

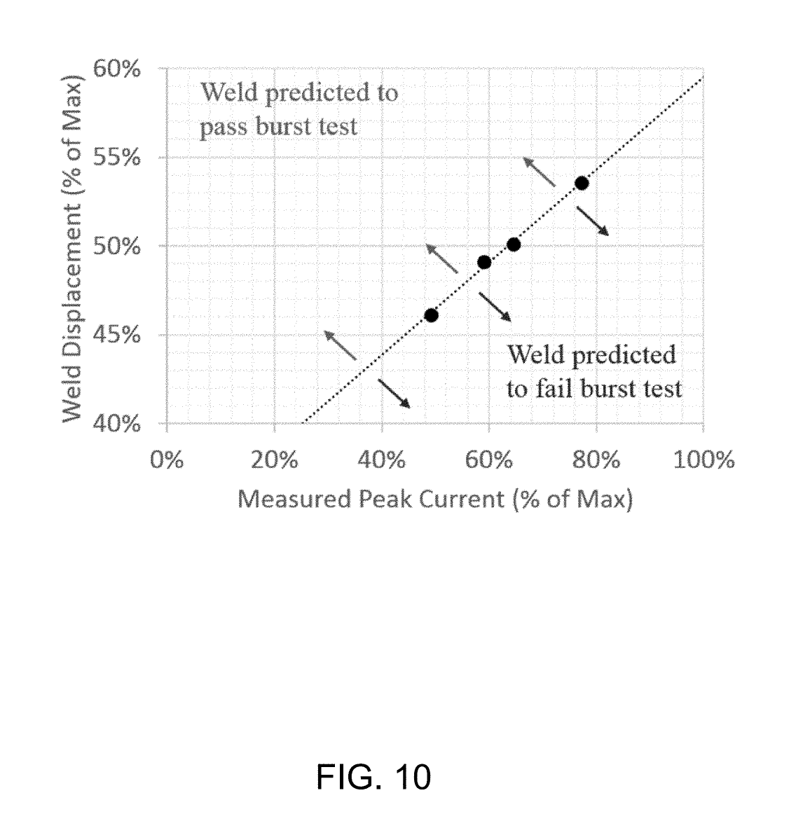

Second, rather than performing destructive or non-destructive analyses to verify weld quality, examination of the post-weld conditions is a quick and easy check to determine the quality of a weld. FIG. 10 shows a prediction of the minimum weld displacement for successful weld joints that pass burst testing based on the measured peak current. By examining the measured current for any given weld, if the weld displacement exceeded the threshold values from this correlation, the weld was a success. Falling below these threshold values in weld displacement would be cause for rejection. This simple relationship between measured current and measured displacement can be used as a quick in-process tool for determining weld quality and acceptance. Results of the burst test showed that performance can be accurately predicted based on weld current and weld displacement values.

The results of the testing showed that weld current and weld displacement are the primary parameters affecting weld quality. A linear relationship exists between weld current and weld displacement, with weld current a defined input parameter and weld displacement a measured output value based on the weld conditions. Burst test performance can be accurately predicted based on weld current and weld displacement.

Various implementations, such as fuel rod end caps, methods of welding, and methods of analyzing welds, have been described above.

Each and any of the end caps described above and claimed below can be welded, such as by resistance pressure welding or pressure resistance welding, to a cladding tube to form a fuel rod.

For example, described above is a method comprising resistance pressure welding a Fe-12Cr-1MoV (HT9) end cap of a nuclear fuel rod to a Fe-12Cr-1MoV (HT9) cladding tube of the nuclear fuel rod to yield a weld joint between the end cap and the cladding tube. The method may include monitoring one or more weld parameters of the resistance pressure welding operation, the one or more weld parameters including at least one of weld current, weld force, cladding tube extension and weld duration; and classifying the weld joint as satisfying a weld quality condition if the resistance pressure welding operation is performed with one or more of the weld parameters satisfying a predetermined weld parameter condition. Additionally or alternately, the method may include monitoring at least four weld parameters including weld current, weld force, tube extension and weld duration; and classifying the weld joint as satisfying a weld quality condition if the resistance pressure welding operation is performed with each of monitored weld parameters satisfying an individual predetermined weld parameter condition. The weld current can be monitored by measuring the weld current, the weld force can be monitored by measuring the weld displacement, the tube extension can be monitored by measuring the upset dimension, and/or the weld duration can be monitored by visual appearance.

As another example, described above is a resistance pressure welding system comprising an end cap electrode coupled to a weld transformer and configured to secure to an end cap of a nuclear fuel rod, the end cap being formed of Fe-12Cr-1MoV (HT9) material, and a cladding electrode coupled to the weld transformer and configured to secure to a cladding tube of the nuclear fuel rod, the cladding tube being formed of Fe-12Cr-1MoV (HT9) material, the end cap electrode and cladding electrode being further configured to resistance pressure weld the end cap to the cladding tube with an electrical current provided by a power supply through the weld transformer.

The above specification provides a complete description of the structure and use of exemplary implementations of the invention. The above description provides specific implementations. Features and/or elements may be interchanged among the various implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about.” Accordingly, unless indicated to the contrary, any numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Since many implementations of the invention can be made without departing from the spirit and scope of the invention, the invention resides in the claims hereinafter appended. Furthermore, structural features of the different implementations may be combined in yet another implementation without departing from the recited claims.

1. An end cap for a nuclear fuel rod, the end cap comprising a tip end, an opposite abutment end for attaching to a cladding tube, and an exterior surface proximate the abutment end; the abutment end having a recess therein and an annular shoulder defined by the outer surface and an outer wall of the recess, the outer wall of the recess forming an angle, with respect to the exterior surface and proximate the abutment end, no less than 5 degrees.

2. The end cap of claim 1, wherein the outer wall of the recess forms an angle, with respect to the exterior surface at the abutment end, no less than 5 degrees.

3. The end cap of claim 1, wherein the recess is a groove defined by the outer wall and an inner wall, the abutment end further having a central pedestal defined by the inner wall.

4. The end cap of claim 3, wherein the groove has a width at the abutment end between the angled outer wall and the inner wall of 1-2 mm.

5. The end cap of claim 1, wherein the recess has a depth of 0.5-5 mm.

6. The end cap of claim 1, wherein the angle is 10-20 degrees. (Original) The end cap of claim 1, wherein the angle is 70-80 degrees.

8. The end cap of claim 1 in conjunction with a cladding tube having a wall thickness, the annular shoulder being at least 0.05 mm wider than the wall thickness of the cladding tube.

9. The end cap of claim 1 in conjunction with a cladding tube having a wall thickness, the annual annular shoulder being at least 0.1 mm wider than the wall thickness of the cladding tube.

10. The end cap of claim 1 in conjunction with a cladding tube, each of the cladding tube and the end cap comprising HT9.

11. An end cap for a nuclear fuel rod, the end cap comprising an abutment end for attaching to a cladding tube, the abutment end having an annular shoulder and a recess having an outer wall defining the annular shoulder and forming an angle no less than 95 degrees with respect to the annular shoulder.

12. The end cap of claim 11, wherein the angle is 100-165 degrees.

13. The end cap of claim 11, wherein the recess has a depth of 0.5-5 mm.

14. The end cap of claim 11, wherein the recess is a groove defined by the outer wall and an inner wall, the abutment end further having a central pedestal defined by the inner wall.

15. The end cap of claim 14, wherein the annular groove has a width at the abutment end of 1-2 mm.

16. The end cap of claim 11 in conjunction with a cladding tube having a wall thickness, the annular shoulder being at least 0.05 mm wider than the wall thickness of the cladding tube.

17. The end cap of claim 11 in conjunction with a cladding tube having a wall thickness, the annual annular shoulder being at least 0.1 mm wider than the wall thickness of the cladding tube.

18. The end cap of claim 11 in conjunction with a cladding tube, each of the cladding tube and the end cap comprising HT9.

19. A method of forming a fuel rod, the method comprising:
providing an end cap having an angled recess in an abutment end, the recess having an outer wall with an outer wall angle, and attaching an end cap electrode to the end cap;
providing a cladding tube and attaching a cladding electrode thereto;
abutting the end cap to the cladding tube;
applying a current from the end cap electrode to the cladding electrode while applying a compressive force to the end cap and the cladding tube; and
plastically deforming a portion of the end cap and/or the cladding tube to form a weld joint.

20. The method of claim 19, wherein the outer wall angle is at an angle of no less than 95 degrees to the abutment end.

21. The method of claim 19, wherein the outer wall angle is at an angle of no less than 5 degrees to an exterior surface of the end cap proximate the abutment end.

22. The method of claim 19, wherein the recess defines a shoulder on the end cap, and wherein the method comprises abutting the shoulder with the cladding tube.

23. The method of claim 19, wherein at least one of the end cap and the cladding tube comprises HT9.

24. The method of claim 23, wherein each of the end cap and the cladding tube comprises HT9.
